(19) United States
(12) Patent Application Publication
(10) Pub. No.: US 2012/0210277 A1
(43) Pub. Date: Aug. 16, 2012

(54) USAGE BASED SCREEN MANAGEMENT

(75) Inventors: Nicholas S. Bowen, NEWTON, CT (US); Dimitri Kanevsky, OSSINING, NY (US); Pamela A. Nesbitt, RALEIGH, NC (US); Tara N. Sainath, NEW YORK, NY (US)

(73) Assignee: INTERNATIONAL BUSINESS MACHINES CORPORATION, ARMONK, NY (US)

(21) Appl. No.: 13/025,854

(22) Filed: Feb. 11, 2011

(51) Int. Cl. G06F 1/26; G06F 3/048; G06F 1/24

(52) U.S. Cl. 715/859; 713/100

(57) ABSTRACT

An apparatus and method are provided for a power saving for multi-media output devices that belong to two or more interconnected devices. The method includes receiving a set of predetermined criteria associated with at least one of application type, user behavior, and user characteristics. The method further includes selectively modifying portions of at least one of the multi-media output devices in accordance with the set of predetermined criteria. The one or more portions are less than an entirety of the at least one of the multi-media output devices.

### BACKGROUND

1. Technical Field

The present invention relates generally to multi-media output devices and, in particular, to usage based management such as screen management.

2. Description of the Related Art

In an effort to save power most laptops and portable devices have power-management capabilities and settings which include screen dimming at various points in the usage cycle of these devices. Examples include dimming immediately after unplugging a laptop from a power source or dimming the screen of a cellular telephone within a certain time of initiating use. The dimming occurs for the entire screen and sometimes causes difficulties such as making it hard to see the number you are dialing.

There are many times when using an application that you need see only the portion of the screen in which you are working. It would be advantageous to have alternative methods of saving battery power which are better customized to the user and application and which don't interfere with one's ability to see a critical part of the screen at a given time.

### SUMMARY

According to an aspect of the present principles, there is provided a power saving method for multi-media output devices that belong to two or more interconnected devices. The method includes receiving a set of predetermined criteria associated with at least one of application type, user behavior, and user characteristics. The method further includes selectively modifying portions of at least one of the multi-media output devices in accordance with the set of predetermined criteria. The one or more portions are less than an entirety of the at least one of the multi-media output devices.

According to another aspect of the present principles, there is provided a power saving apparatus for multi-media output devices that belong to two or more interconnected devices. The apparatus includes a multimedia usage monitor for determining application type and user behavior, one or more biometric sensors for determining user characteristics, and a manager in signal communication with the multimedia usage monitor and the one or more biometric sensors. The manager is for modifying portions of at least one of the multi-media output devices in accordance with a set of predetermined criteria associated with at least one of the application type, the user behavior, and the user characteristics.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram showing an exemplary usage based screen management system 199 is shown, in accordance with an embodiment of the present principles;

FIG. 2 shows the screen manager 101 of FIG. 1 in further detail, in accordance with an embodiment of the present principles;

FIG. 3A shows an exemplary text application highlighting 300, in accordance with an embodiment of the present principles;

FIG. 3B shows an exemplary mouse pointer highlighting 330, in accordance with an embodiment of the present principles;

FIG. 3C shows an exemplary IDE 360 with more than one simultaneous bright area, in accordance with an embodiment of the present principles;

FIG. 4 shows the biometrics processor 200 of FIG. 2 in further detail, in accordance with an embodiment of the present principles;

FIGS. 5A-C show an example of rule based energy analysis 500, in accordance with an embodiment of the present principles; and

FIG. 6 shows a method 699 for usage based screen management, in accordance with an embodiment of the present principles.

### DETAILED DESCRIPTION OF PREFERRED EMBODIMENTS

The present principles are directed to usage based management such as, for example, but not limited to, screen management, sound management, tactile output management, and so forth. Advantageously, the present principles provide alternate methods of saving battery power which are customized to the user and application currently being utilized by the user. In addition, the present principles advantageously provide such usage based screen management in a manner that does not interfere with the ability of the user to see a critical part of the screen at a given time.

In an embodiment, a screen manager lowers the intensity (dims) most of the screen except for predetermined portions such as around the cursor. Keystrokes or other mechanisms could be used to temporarily brighten the entire screen or some other portion of the screen if you need to check on something outside the area which is currently bright. The shape and location(s) of the bright area(s) could be configured on a per-application basis or could be based on a set of rules.

The screen manager for the particular display device lowers the intensity of most of the screen through a number of potential methods. The area in which one is working remains bright according to a number of criteria described below. Of course, it is to be appreciated that the present principles are not limited to solely the following criteria and, thus, other criteria, as readily contemplated by one of ordinary skill in the related art in view of the teachings of the present principles provided herein, can be used, while maintaining the spirit of the present principles. The size and range of the bright area varies according to key indicators such as the way in which a person works or the type of application currently in use.

Items relating to the screen which can be configured include, but are not limited to: size of bright area; number of bright areas; what is bright and what is dim; and how dim the rest of the screen is. Of course, it is to be appreciated that the present principles are not limited to solely the preceding configurable items and, thus, other configurable items, as readily contemplated by one of ordinary skill in the related art in view of the teachings of the present principles provided herein, can be used, while maintaining the spirit of the present principles. For example, even the shapes of the areas to be illuminated as well as the shapes of the areas to be dimmed may be configured. Such configuration can be made on a set of preferences that can include, but is not limited to, application type, user behavior, and user characteristics.

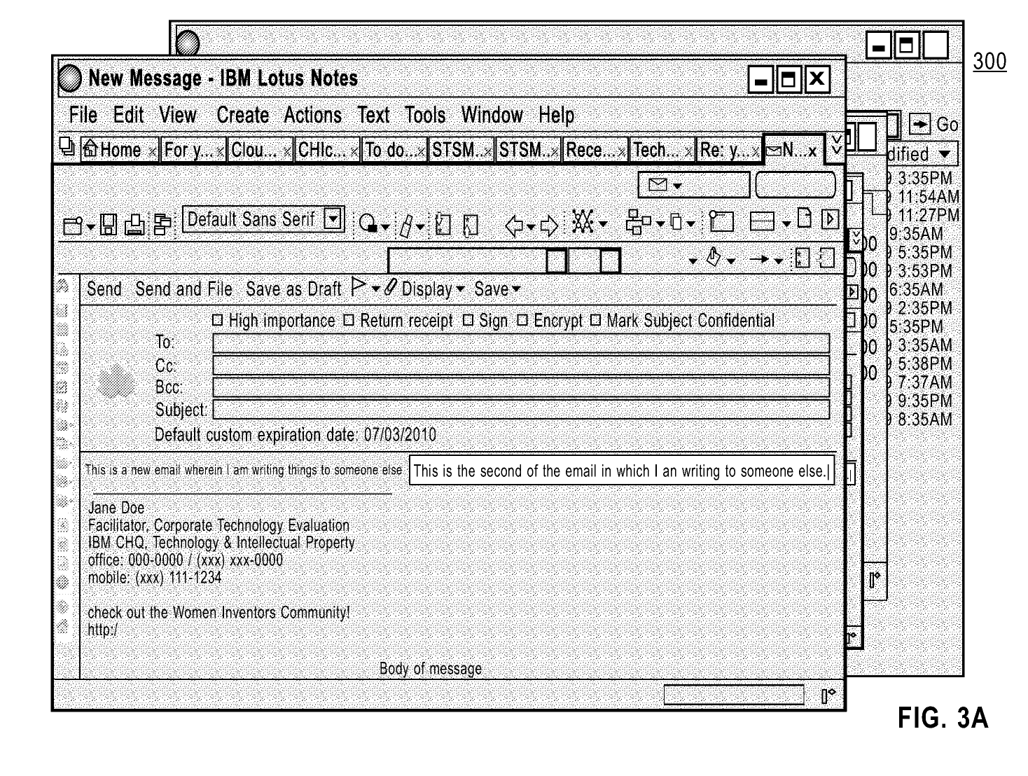

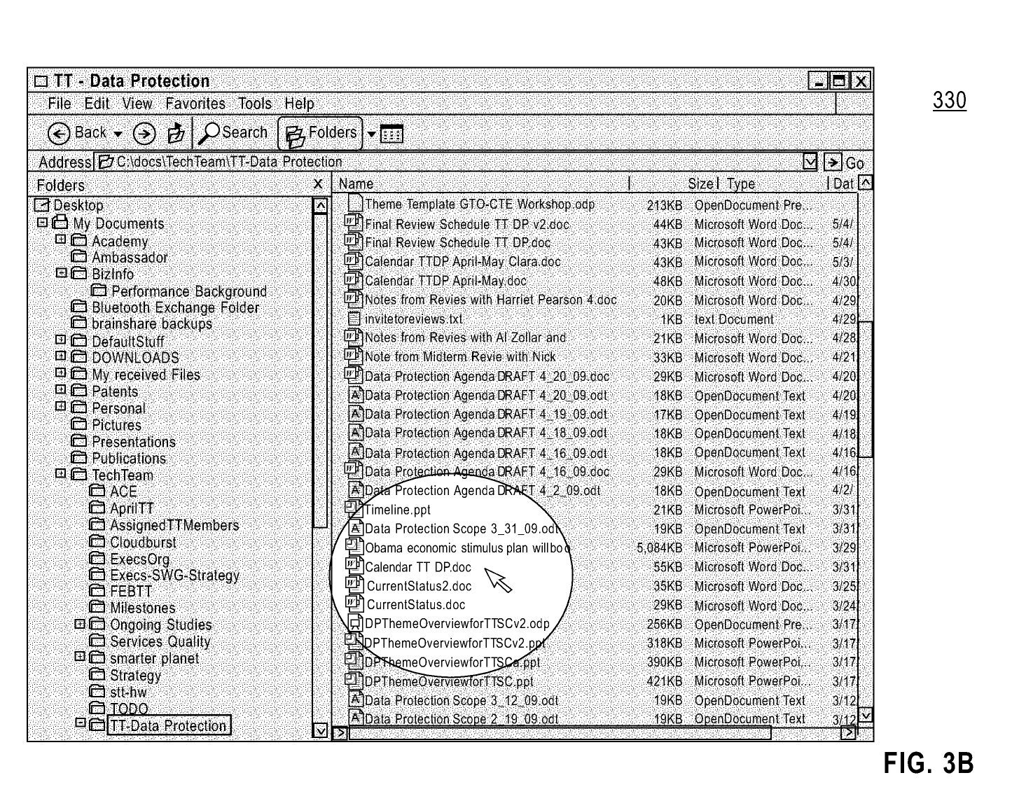

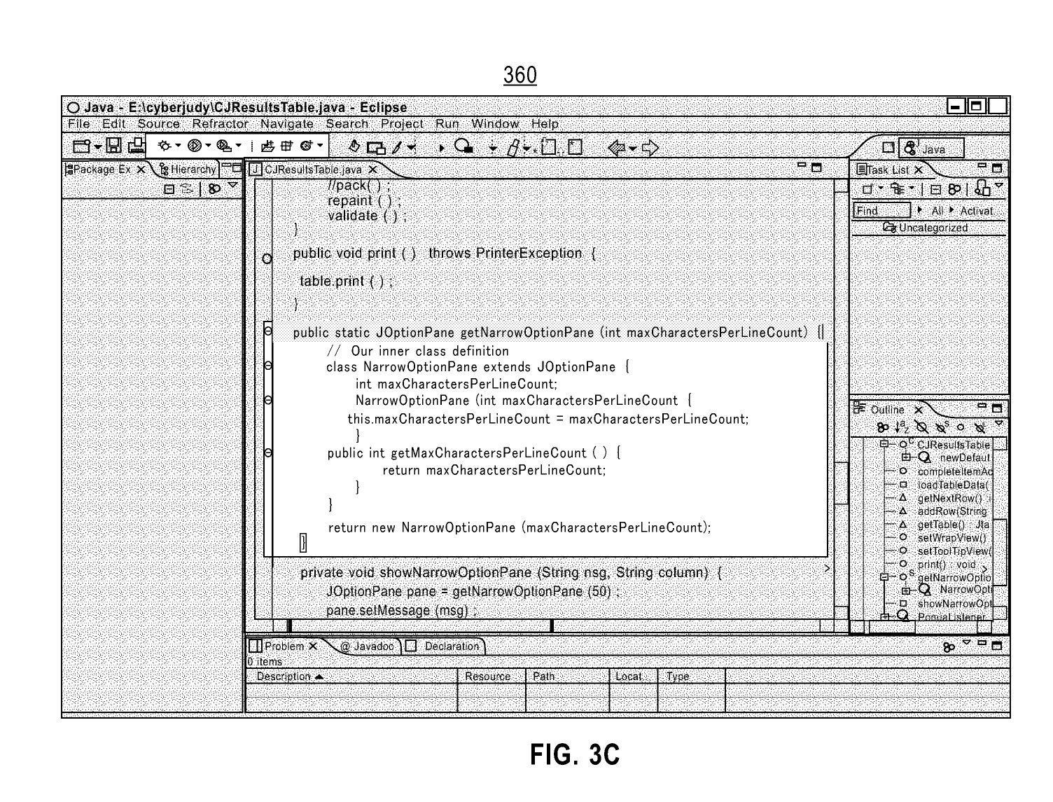

Each application, or application type, could have a set of preferences associated with it. For example, text applications get only the last x (e.g., where x is an integer greater than 1) words and the current word made bright (see FIG. 3A). As another example, graphical apps get the entire window or a circle around the mouse pointer (see FIG. 3B). As yet another example, IDE's get the current method and the toolbar bright (see FIG. 3C). Of course, it is to be appreciated that the present principles are not limited to solely the preceding preferences and, thus, other preferences, as readily contemplated by one of ordinary skill in the related art in view of the teachings of the present principles provided herein, can be used, while maintaining the spirit of the present principles.

The way in which you are using the peripherals could help to identify the type of application and, thus, the type of dimming which should be performed. For example, typing steadily would indicate a text application and would initiate the dimming sequence defined for a text app. As another example, using the mouse and dragging it around might indicate a drawing application or other. Of course, it is to be appreciated that the present principles are not limited to solely the preceding ways of peripheral use and types of dimming and, thus, other ways of peripheral use and types of dimming, as readily contemplated by one of ordinary skill in the related art in view of the teachings of the present principles provided herein, can be used, while maintaining the spirit of the present principles.

It is to be further appreciated that as used herein, the phrase “multi-media output devices” refers to any of display screens, speakers, and so forth. That is, the phrase “multi-media output devices” refers to and includes any type of medium capable of directly presenting video, audio, or tactile information to a user.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

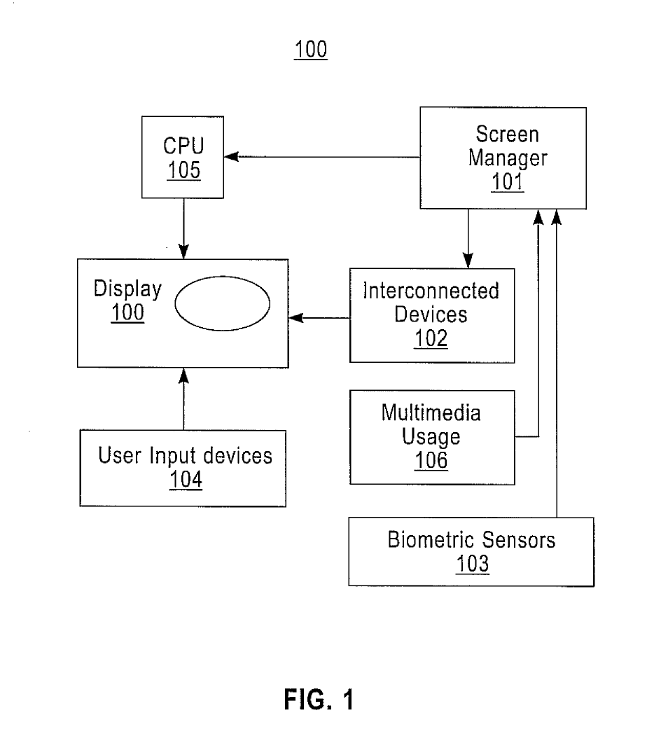

Referring now to the drawings in which like numerals represent the same or similar elements and initially to FIG. 1, an exemplary usage based screen management system 199 is shown, in accordance with an embodiment of the present principles. The system 199 includes a display screen 100, a screen manager 101, interconnected devices 102, biometric sensors 103, user input devices 104, a central processing unit (CPU) 105, and a multimedia usage monitor 106.

Regarding the display screen 100, the bright ellipse shown therein is the area with higher intensity.

Regarding the screen manager 101, the same controls all modules which affect the intensity of pixels within the screen. The screen manager 101 also synchronizes images between the display screen 100 and the interconnected devices 102 so that if an image is duplicated on both the display screen 100 and the interconnected devices 102, then the intensity of the image on one device is reduced and is strengthened on the other device. Moreover, the screen manager 101 processes biometric sensor information from biometric sensors 103. Further, while shown separately from the CPU 105, in an embodiment, the screen manager 101 operates within the CPU 105. Also, the screen manager 101 receives information about multimedia usage from multimedia usage monitor 106.

Regarding the interconnected devices 102, the same can include, but are not limited to, a cell phone (e.g., an IPHONE), a tablet (e.g., an IPAD), other laptops, recorders, and so forth. It is to be appreciated that the interconnected devices 102 can include any device that can be connected to a computer either directly or through a network.

Regarding the biometric sensors 103, the same can include, but are not limited to, a camera, microphones, touch sensors, mouse sensors, and so forth. These biometric sensors 103 provide information about the user such as age, attention (e.g., focus of attention (where the user is looking) attention span (how long the user looked at a particular point/location)), hearing quality (e.g., as indicated by the presence of hearing aids), vision quality (e.g., as indicated by the type of glasses and/or thickness of the glasses), and so forth. It is to be appreciated that such hearing quality and vision quality may be judged based on respective thresholds. For example, regarding the vision quality, a lens thickness greater than a pre-specified threshold may be used to indicate naturally (i.e., unaided) poor vision, thus possibly prompting the screen manager to increase a corresponding font size of fonts that are displayed to the user.

Regarding the user input devices 104, the same provide knowledge about the activities of the user. Such activities can include, but are not limited to, speaking via a microphone, using a mouse, typing on a keyboard, and so forth.

Regarding the multimedia usage monitor 106, in an embodiment, if a user wants to focus on text processing, the multimedia usage module can reduce the audio information.

It is to be appreciated that at least some of the functions described with respect to the preceding elements may be performed by other elements, as would be readily understood and contemplated by one of ordinary skill in the art.

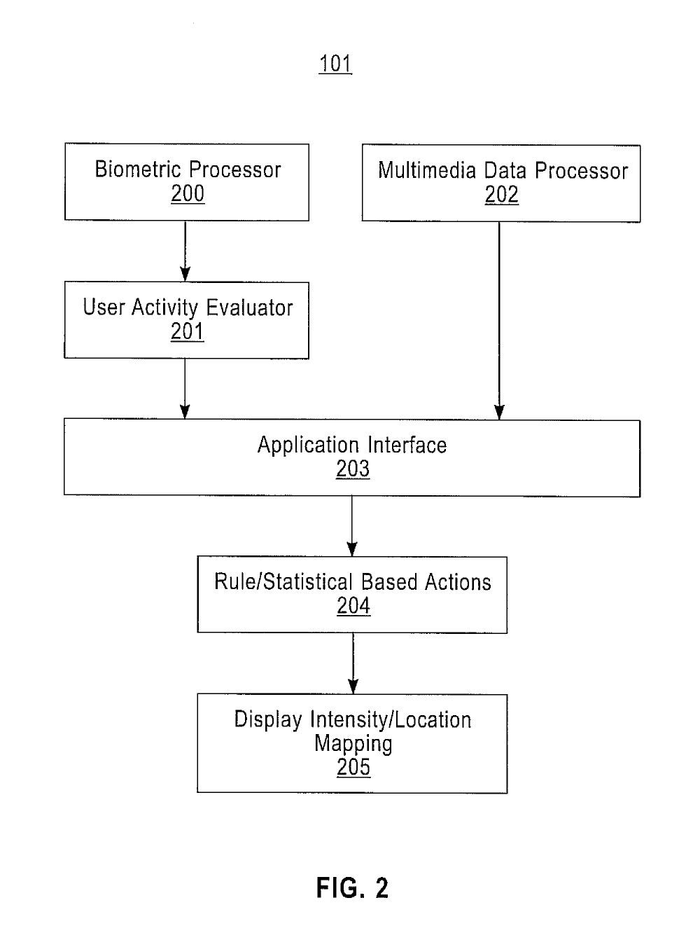

FIG. 2 shows the screen manager 101 of FIG. 1 in further detail, in accordance with an embodiment of the present principles. The screen manager 101 includes a biometric processor 200, a user activity evaluator 201, a multimedia data processor 202, an application interface 203, a rule/statistical based actions module (also interchangeably referred to herein as a “modification determiner”) 204, and a display intensity/location mapping module 205.

Regarding the biometric processor 200, the same analyzes biometric data from the biometric sensors 103. For example, from voice, the biometric processor 200 can identify if the user is tired. From visual images, the biometric processor 200 can identify the age of the user. If the user is wearing glasses, the type of glasses the user is wearing can be used to judge whether the user needs big fonts. From the behavior of the user such as, but not limited to, how the user focuses on text, the biometric processor 200 can identify if the user has dyslexia. From (i.e., using) a camera, the biometric processor 200 can identify if the user has hearing devices.

Regarding the user activity evaluator 201, the same receives information from the biometric processor 200 about the activities of the user. For example, is the user touching the mouse or keyboard? Does the user need a large font and sharp contrast? Does the user need the audio to be loud?

Regarding the multimedia data processor 202, the same has information on the intensity of different media (i.e., audio, video) and varies the intensity of these different applications depending on the needs of the user. For example, if the user wants to listen to music, then the multimedia data processor 202 will diminish the intensity of visual information and only maintain the audio loud.

Regarding the application interface 203, the same creates an interface for various types of applications depending on the requirement(s) for energy savings. For example, if there is little energy left on a battery, this affects how the computer displays intensity for various applications. The application interface 203 also has information about user activity so that parts of the screen which require more attention by the user are displayed with greater intensity and parts of the screen requiring less attention are displayed with lower intensity. Examples of this can be seen in FIGS. 3A, 3B, and 3C described in further detail herein. For example, as mentioned above, text applications get only the last x words and the current word made bright (see FIG. 3A), graphical apps get the entire window or a circle around the mouse pointer (see FIG. 3B), and IDE's get the current method and the toolbar bright (see FIG. 3C).

Regarding the rule/statistical based actions module 204, the same is used to decide how to operate the display. These rules can include how to control the intensity of the screen based on the actions of the users. The actions can be based on statistic rules including, but not limited to, when the user is moving mouse, what is the probability the user is actually looking at the cursor so that the system should intensify an important area, and so forth. The actions could also be rule-based. For example, if the user is moving the mouse, then the rule/statistical based actions module 204 can cause the direct activation (illumination) of the area on the screen around the cursor.

Regarding the display intensity/location mapping module 205, the same receives information from the rule/statistical based actions module 204 to decide what location and pixel mappings of the display screen 100 to intensify more or less.

It is to be appreciated that at least some of the functions described with respect to the preceding elements may be performed by other elements, as would be readily understood and contemplated by one of ordinary skill in the art.

FIG. 3A shows an exemplary text application highlighting 300, in accordance with an embodiment of the present principles. In the exemplary text highlighting 300, an entire sentence where the cursor is placed is highlighted and is, thus, slightly brighter than the rest of the display screen 100.

FIG. 3B shows an exemplary mouse pointer highlighting 330, in accordance with an embodiment of the present principles. In the exemplary mouse pointer highlighting 330, the display screen 100 is highlighted around an area surrounding the cursor. Moreover, in the exemplary mouse pointer highlighting 330, the non-highlighted portions of the display screen 100 are dimmer than, for example, the non-highlighted portions of the display screen 100 in the exemplary text highlighting 300.

FIG. 3C shows an exemplary IDE 360 with more than one simultaneous bright area, in accordance with an embodiment of the present principles.

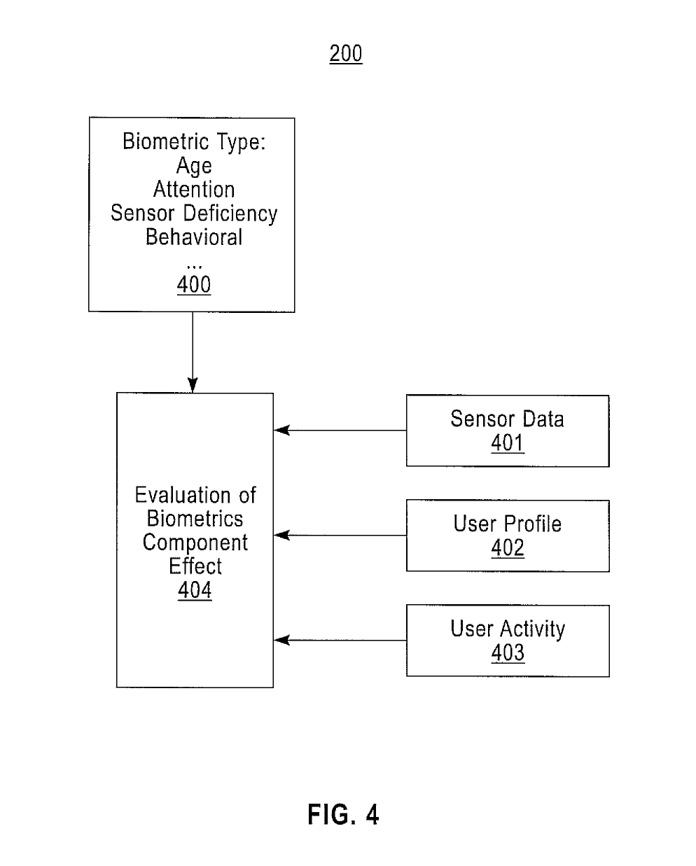

FIG. 4 shows the biometrics processor 200 of FIG. 2 in further detail, in accordance with an embodiment of the present principles. The biometrics processor 200 includes an evaluator of biometrics component effects 404. The evaluator of biometrics component effects 404 receives information such as biometric type 400, sensor data 401, user profile 402, and user activity 403.

Regarding the biometric type 400, the same includes, but is not limited to, age, attention, sensor deficiency, behavioral biometrics, and so forth. Behavioral biometrics are described in U.S. Pat. No. 6,421,453, issued on Jul. 16, 2002 to Kanevsky et al., and having a common assignee, the disclosure of which is incorporated by reference herein. Other types of biometrics are defined in U.S. Pat. No. 6,665,644, issued on Dec. 16, 2003 to Kanevsky et al., and having a common assignee, the disclosure of which is incorporated by reference herein.

Regarding the sensor data 401, the same includes sensor data from the user.

Regarding the user profile 402, the same includes, but is not limited to, age, physical descriptions, and so forth.

Regarding the evaluator of biometrics components effects 404, the same uses the sensor data 401, the user profile 402, and the user activity 403. For example, the sensor data 401 can indicate that the user is sitting close to a screen and is using heavy (i.e., thick) glasses. The user profile 402 can include age. The user activity 403 can indicate that the user is watching a movie. Using information from these 3 inputs, the evaluator 404 can evaluate the impact of biometrics on the user.

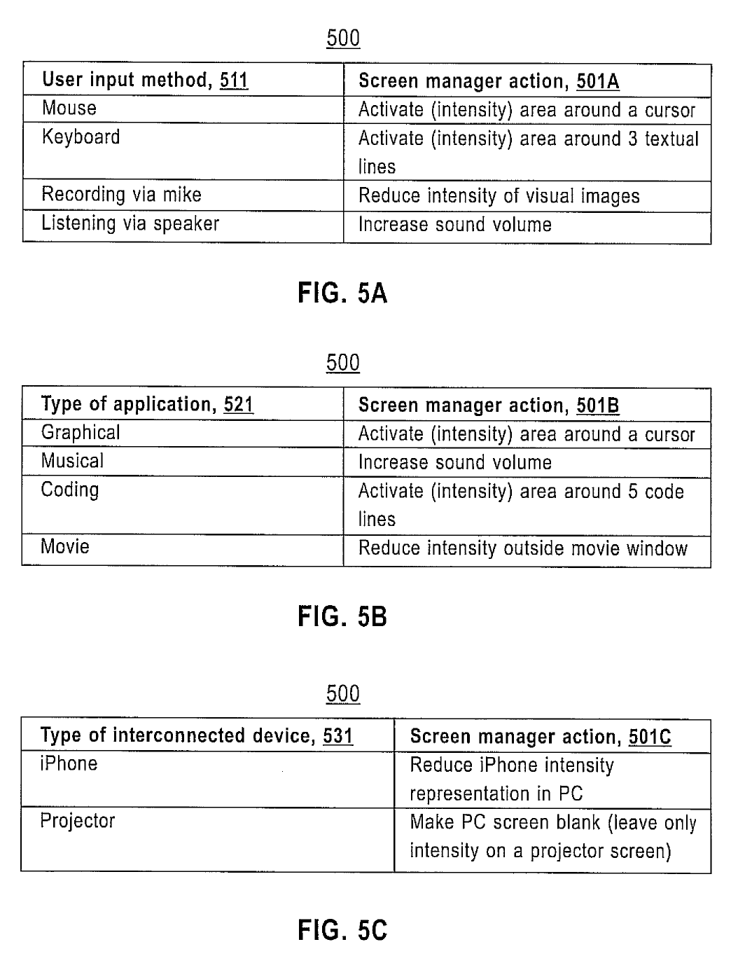

FIGS. 5A-C show an example of rule based energy analysis 500, in accordance with an embodiment of the present principles.

Regarding FIG. 5A, the rule based energy analysis 500 specifies screen manager actions 501A that are responsive to a respective user input method 511. For example, when the user is using a mouse, then an area around the cursor is activated (e.g., illumination is activated and/or illumination intensity is increased relative to other portions of the display screen 100). When the user is using a keyboard, then an area around 3 textual lines is activated. When the user is recording via a microphone (mike), then the intensity of visual images is reduced. When the user is listening via a speaker, then the sound volume is increased.

Regarding FIG. 5B, the rule based energy analysis 500 further specifies screen manager actions 501B that are responsive to a respective type of application 521. For example, when the application type is graphical, then an area around the cursor is activated. When the type of application is musical, then the sound volume is increased. When the type of application is coding, then an area around 5 code lines is activated. When the type of application is a movie, then the intensity outside the movie window is reduced.

Regarding FIG. 5C, the rule based energy analysis 500 also specifies screen manager actions 501C that are responsive to a respective type of interconnected device 531. For example, when the interconnected device type is a cellular telephone (e.g., an IPHONE), then an IPHONE (or other cellular telephone) intensity representation on the display screen 100 is reduced. When the interconnected device type is a projector, then the display screen 100 is made blank, leaving intensity only on the corresponding projector screen.

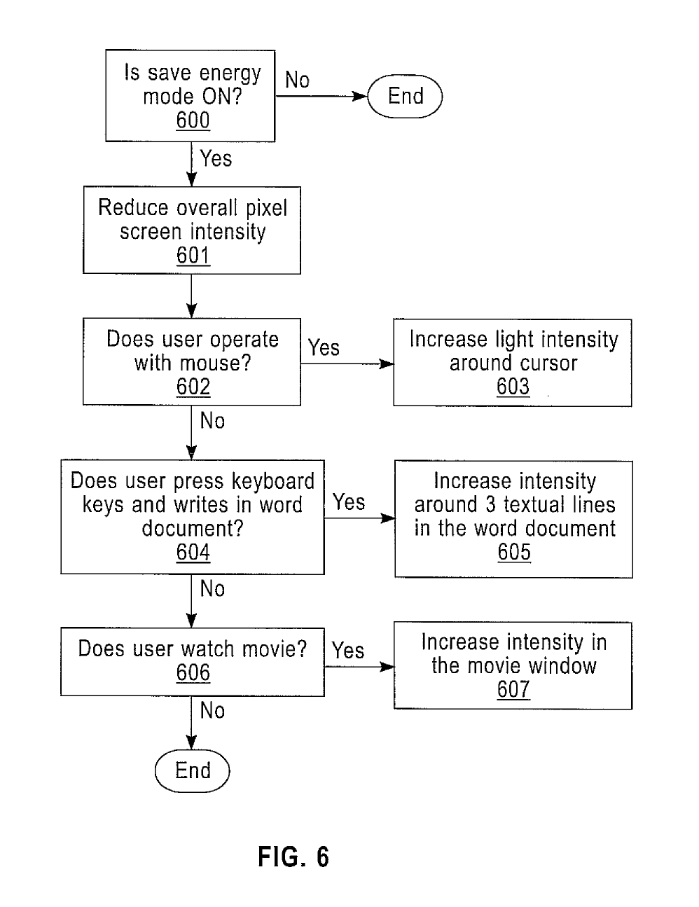

FIG. 6 shows a method 699 for usage based screen management, in accordance with an embodiment of the present principles. At step 600, it is determined whether or not a “save energy mode” is on (enabled). If so, then the method proceeds to step 601. Otherwise, the method is terminated. At step 601, the overall pixel screen intensity is reduced. At step 602 it is determined whether or not the user is operating with (i.e., using) the mouse. If so, then the method proceeds to step 603. Otherwise, the method proceeds to step 604. At step 603, the light intensity around the cursor is increased. At step 604, it is determined whether or not the user pressed the keyboard keys and writes in a word (i.e., text) document. If so, then the method proceeds to step 605. Otherwise, the method proceeds to step 606. At step 605, the intensity around 3 textual lines in the word (i.e., text) document is increased. At step 606, it is determined whether or not the user is watching a movie. If so, then the method proceeds to step 607. Otherwise, the method is terminated. At step 607, the intensity in the movie window is increased.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A power saving method for multi-media output devices that belong to two or more interconnected devices, the method comprising:
receiving a set of predetermined criteria associated with at least one of application type, user behavior, and user characteristics; and
selectively modifying portions of at least one of the multi-media output devices in accordance with the set of predetermined criteria, the one or more portions being less than an entirety of the at least one of the multi-media output devices.

2. The method according to claim 1, wherein the multi-media output devices comprise at least one of a self-luminous display, one or more speakers, a display having one or more vibrating parts for providing a tactile sensation to a user, and a display with at least one integrated speaker.

3. The method according to claim 2, wherein said modifying step comprises at least one of dimming one or more of the portions of the at least one of the multi-media output devices, and changing a volume of at least one but not all of the one or more speakers.

4. The method according to claim 2, wherein the application type comprises at least one of a graphic application, a text application, an audio application, a coding application, and a movie application.

5. The method according to claim 4, wherein said modifying step comprises illuminating at least one of the portions that is disposed around a cursor while concurrently dimming at least one other one of the portions when the application type comprises the graphic application, illuminating at least one of the portions that is disposed around X preceding words and a current word while concurrently dimming at least one other one of the portions when the application type comprises the text application, increasing a sound volume of at least one but not all of the one or more speakers when the application type comprises the audio application, illuminating at least one of the portions that is disposed around X code lines while concurrently dimming at least one other one of the portions when the application type comprises the coding application, and illuminating a movie window while concurrently dimming area outside of the movie window when the application type comprises the movie application, wherein X is an integer greater than one.

6. The method according to claim 1, wherein user behavior comprises at least one user action, the at least one user action comprising at least one of moving a mouse, typing on a keyboard, recording using a microphone, and listening to sound output from a speaker.

7. The method according to claim 6, wherein said modifying step comprises at least one of illuminating at least one of the portions that is disposed around a cursor while concurrently dimming at least one other one of the portions when the user action comprises moving the mouse, illuminating at least one of the portions that is disposed around X textual lines while concurrently dimming at least one other one of the portions when the user action comprises typing on the keyboard, reducing an illumination intensity of visual images when the user action comprises recoding using the microphone, and increasing the sound volume when the user action comprises listing to the sound emanating from the speaker, wherein X is an integer greater than one.

8. The method according to claim 1, wherein the user characteristics comprise user biometrics.

9. The method according to claim 1, wherein the two or more interconnected devices comprise at least one of a cellular telephone, a notebook computer, a laptop computer, one or more speakers, a recorder, and a projector.

10. The method according to claim 1, wherein said modifying step comprises maintaining an illumination intensity around at least one of the portions while concurrently dimming at least a first portion and a second portion from among the remaining portions responsive to the application type, wherein the first portion is made less dim than the second portion to provide a higher degree of visibility thereat.

11. The method according to claim 1, further comprising configuring a shape and a location of at least one of the portions to be modified in accordance with the set of predetermined criteria.

12. A power saving apparatus for multi-media output devices that belong to two or more interconnected devices, the apparatus comprising:
a multimedia usage monitor for determining application type and user behavior;
one or more biometric sensors for determining user characteristics; and
a manager, in signal communication with the multimedia usage monitor and the one or more biometric sensors, for modifying portions of at least one of the multi-media output devices in accordance with a set of predetermined criteria associated with at least one of the application type, the user behavior, and the user characteristics.

13. The apparatus according to claim 12, wherein said multimedia usage monitor determines the user behavior responsive to a particular input device being used by a user.

14. The apparatus according to claim 12, wherein the biometric sensors comprise at least one of a camera, a microphone, a touch sensor, and a mouse sensor.

15. The apparatus according to claim 12, wherein the biometric sensors provide information regarding an age, an exhibited level of attention, a hearing quality, and a vision quality of a user.

16. The apparatus according to claim 15, wherein the multi-media output devices comprise at least one speaker, and said manager increases a volume of the at least one speaker when the hearing quality of the user is determined to be below a pre-specified threshold responsive to the information provided by the biometric sensors regarding the hearing quality of the user.

17. The apparatus according to claim 15, wherein said manager increases at least one of a font size and a contrast level when the vision quality of the user is determined to be below a pre-specified threshold responsive to the information provided by the biometric sensors regarding the vision quality of the user.

18. The apparatus according to claim 12, wherein said manager comprises an illumination intensity location mapper for determining which of the portions of the at least one of the multi-media output devices to modify in accordance with the set of predetermined criteria.

19. The apparatus according to claim 12, wherein said manager comprises a modification determiner for determining how to modify the portions of the at least one of the multi-media output devices in accordance with the set of predetermined criteria, the modification determiner determining at least some modifications based on rules and statistics.

20. The apparatus according to claim 12, wherein said manager modifies the portions of the at least one of the multi-media output devices in accordance with the set of predetermined criteria by maintaining an illumination intensity around at least one of the portions while concurrently dimming at least a first portion and a second portion from among the remaining portions responsive to the application type, wherein the first portion is made less dim than the second portion to provide a higher degree of visibility thereat.

21. The apparatus according to claim 12, wherein said manager configures a shape and a location of at least one of the portions to be modified in accordance with the set of predetermined criteria.

22. A computer readable storage medium comprising a computer readable program, wherein the computer readable program when executed on a computer causes the computer to perform the following steps:
receiving a set of predetermined criteria associated with at least one of application type, user behavior, and user characteristics; and
modifying portions of at least one of multi-media output devices in accordance with the set of predetermined criteria.

23. The computer readable storage medium according to claim 22, wherein said modifying step comprises at least one of dimming one or more of the portions of the at least one of the multi-media output devices, and changing a volume of at least one speaker.

24. The computer readable storage medium according to claim 22, wherein said modifying step comprises maintaining an illumination intensity around at least one of the portions while concurrently dimming at least a first portion and a second portion from among the remaining portions responsive to the application type, wherein the first portion is made less dim than the second portion to provide a higher degree of visibility thereat.

25. The computer readable storage medium according to claim 22, further comprising the step of configuring a shape and a location of at least one of the portions to be modified in accordance with the set of predetermined criteria.
